(19) United States
(12) Patent Application Publication
(10) Pub. No.: US 2021/0149918 A1
(43) Pub. Date: May 20, 2021

(54) INTELLIGENT DATA POOL

(71) Applicant: International Business Machines Corporation, Armonk, NY (US)

(72) Inventor: Ulrich Finkler, Mahopac, NY (US)

(21) Appl. No.: 16/685,143

(22) Filed: Nov. 15, 2019

(51) Int. Cl. G06F 16/27; G06F 16/182; G06F 16/901; G06N 5/00; G06N 5/04; G06N 20/00

(52) U.S. Cl. CPC G06F 16/278; G06F 16/182; G06N 20/00; G06N 5/003; G06N 5/04; G06F 16/9017

(57) ABSTRACT

Techniques regarding intelligent data pools are provided. Embodiments described herein can include a system comprising a memory that can store computer executable components. The system can also comprise a processor that can execute the computer executable components stored in the memory. The computer executable components can comprise a data pool component that performs a semantic analysis of data access patterns across a distributed computing network to partition file system objects independently of a directory structure and into groups with defined temporary access restrictions. The computer executable components can also comprise: a directory component that organizes data into the directory structure by defining sectors on a node of the distributed computing network into an address section; and a partition component that separates metadata from the data of the directory structure and partitions the metadata into the groups within a continuous virtual memory section based on the data access patterns.

### BACKGROUND

The subject disclosure relates to an intelligent data pool, and more specifically, an intelligent data pool embodied as a scheme to organize temporary access limitations and/or resulting status guarantees independently from a file system directory structure and/or incorporate dynamic adaption of the temporary access limitations to shifting access patterns.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products of an intelligent data pool embodied as a scheme to organize temporary access limitations and/or resulting status guarantees independently from a file system directory structure, and/or incorporate dynamic adaption of the temporary access limitations to shifting access patterns are described.

According to an embodiment, a system is provided. The system can comprise a memory that can store computer executable components. The system can also comprise a processor, operably coupled to the memory, that can execute the computer executable components stored in the memory. The computer executable components can comprise a data pool component that can perform a semantic analysis of data access patterns across a distributed computing network to partition file system objects independently of a directory structure and into groups with defined temporary access restrictions.

According to an embodiment, another system is provided. The system can comprise a memory that can store computer executable components. The system can also comprise a processor, operably coupled to the memory, that can execute the computer executable components stored in the memory. The computer executable components can comprise a data pool component that can determine a scheme to organize temporary access limitations of file system objects independently from a file system directory based on data access patterns across a distributed computing network.

According to an embodiment, a computer-implemented method is provided. The computer-implemented method can comprise performing, by a system operatively coupled to a processor, a semantic analysis of data access patterns across a distributed computing network to partition file system objects independently of a directory structure and into groups with defined temporary access restrictions.

According to an embodiment, another computer-implemented method is provided. The computer-implemented method can comprise determining, by a system operatively coupled to a processor, a scheme to organize temporary access limitations of file system objects independently from a file system directory based on data access patterns across a distributed computing network

According to an embodiment, a computer program product for managing data comprised within a distributed computing network is provided. The computer program product can comprise a computer readable storage medium having program instructions embodied therewith. The program instructions can be executable by a processor to cause the processor to perform, by the processor, a semantic analysis of data access patterns across a distributed computing network to partition file system objects independently of a directory structure and into groups with defined temporary access restrictions.

### BRIEF DESCRIPTION OF THE DRAWINGS

FIG. 1 illustrates a block diagram of an example, non-limiting system that can partition file system objects independently of one or more directory structures into groups with temporary limitations in accordance with one or more embodiments described herein.

FIG. 2 illustrates a block diagram of an example, non-limiting system that can generate one or more sector and/or object dictionaries to manage data within a distributed computing network in accordance with one or more embodiments described herein.

FIG. 3 illustrates a block diagram of an example, non-limiting system that can separate metadata from data of a file system directory into groups within one or more continuous sections of virtual address space in accordance with one or more embodiments described herein.

FIG. 4 illustrates a block diagram of an example, non-limiting system that can dynamically adapt partitioning of the metadata within one or more continuous sections of virtual address space based on access patterns in accordance with one or more embodiments described herein.

FIG. 5 illustrates a diagram of example, non-limiting tree-operations that can be performed to facilitate dynamic adaption of the metadata partitioning in accordance with one or more embodiments described herein.

FIG. 6 illustrates a block diagram of an example, non-limiting system that can employ machine learning to predict one or more future access patterns and facilitate partitioning metadata within one or more continuous sections of virtual address space in accordance with one or more embodiments described herein.

FIG. 7 illustrates a flow diagram of an example, non-limiting computer-implemented method that can partition file system objects independently of one or more directory structures into groups with temporary limitations in accordance with one or more embodiments described herein.

FIG. 8 illustrates a flow diagram of an example, non-limiting computer-implemented method that can partition file system objects independently of one or more directory structures into groups with temporary limitations in accordance with one or more embodiments described herein.

FIG. 9 illustrates a flow diagram of an example, non-limiting computer-implemented method that can partition file system objects independently of one or more directory structures into groups with temporary limitations in accordance with one or more embodiments described herein.

FIG. 10 depicts a cloud computing environment in accordance with one or more embodiments described herein.

FIG. 11 depicts abstraction model layers in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Distributed computing solutions in a cloud computing environment and/or cluster environment (e.g., for training machine learning tasks and/or deep learning models) can have requirements for data access beyond traditional single node deployments and markedly different than traditional high-performance computing (“HPC”) requirements. Large datasets (e.g., multiple terabytes (“TB”) and more) can be traversed repeatedly with partial or complete random access. However, loading from separate storage servers can put significant strain on the network infrastructure. For example, 100 computer applications performing 100 epochs of machine learning training on 10 TB of data can cause 10⁵ TB of data traffic if the data set is too large for the local caching capacity of a single computer node.

A solution to reduce the data traffic to storage servers has been to employ local storage, such as supplying each computer node of the network a copy of the training data on a local solid-state drive (“SSD”) and/or a non-volatile memory express (“NVMe”) device. Data can be partitioned such that each computer node can obtain a different piece of the data. However, employing local storage can require deployment of specific data partitioning, forfeits randomization, and/or requires frequent changes to the synchronization between systems. Further, local SSD and/or NVMe devices can be bundled on the computer nodes through a distributed file system to create a large file system having a capacity that is equal to the sum of the computer node capacities. However, bundling SSD and/or NVMe devices can increase latencies in data access.

Traditional file systems and/or distributed file systems can require significant time to traverse, copy, and/or read directories with large numbers of files 118. For example, traversing 1 million items in a dedicated index can be performed in milliseconds; traversing the 1 million items in a local file system of an SSD device can take seconds; and traversing the 1 million items on a distributed file system can take multiple minutes. A root cause of the performance overhead outlined above can be the access to not only the data, but also the file status and/or access permissions (e.g., the consistency of the file system).

Various embodiments of the present invention can be directed to computer processing systems, computer-implemented methods, apparatus and/or computer program products that facilitate the efficient, effective, and autonomous (e.g., without direct human guidance) management of data indexing and/or access across a distributed computing network via a semantic analysis of one or more data access patterns. For example, one or more embodiments described herein can regard organizing one or more temporary access limitations and/or status guarantees characterizing the data independently from a file system directory structure. Additionally, various embodiments can include dynamically adapting the one or more temporary access limitations to shifting access patterns, and/or employing machine learning technology (e.g., deep learning modeling) to extrapolate near future operation requests based on past access sequences.

The computer processing systems, computer-implemented methods, apparatus and/or computer program products employ hardware and/or software to solve problems that are highly technical in nature (e.g., managing data indexing and/or access within a distributed computing network), that are not abstract and cannot be performed as a set of mental acts by a human. For example, an individual, or a plurality of individuals, cannot partition metadata into groups within a continuous virtual memory section to manage temporary access rights to data distributed within a computing network. Various embodiments described herein can reduce the performance overhead of a distributed computing network through the management of file status and access permission to rapidly decrease the operational time required to identify and/or process data across the network. Additionally, the computer processing systems, computer-implemented methods, apparatus and/or computer program products employ hardware and/or software to implement machine learning to approximately predict near future operations based on past operations, and thereby approximate optimal membership of one or more file system objects to a continuous section of virtual address space.

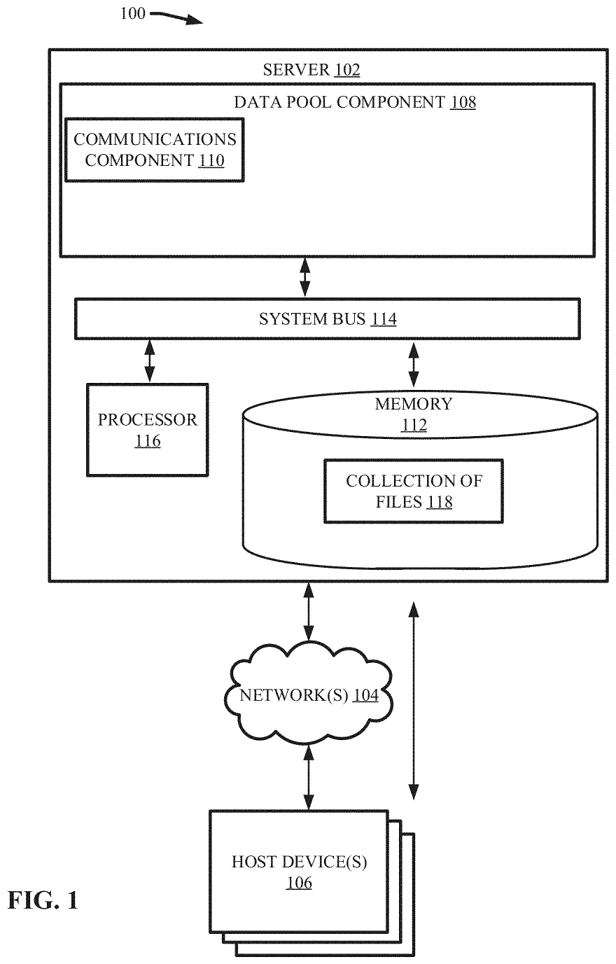

FIG. 1 illustrates a block diagram of an example, non-limiting system 100 that can partition file system objects independently of one or more directory structures into groups with temporary limitations in accordance with one or more embodiments described herein. Repetitive description of like elements employed in other embodiments described herein is omitted for sake of brevity. For instance, one or more embodiments described herein can partition file system objects into an organizational structure that is different than the one or more directory structures. Further, the one or more file system objects can be partitioned with one or more access limitations that can be altered based on past, or predicted near future, data operations. Aspects of systems (e.g., system 100 and the like), apparatuses or processes in various embodiments of the present invention can constitute one or more machine-executable components embodied within one or more machines, e.g., embodied in one or more computer readable mediums (or media) associated with one or more machines. Such components, when executed by the one or more machines, e.g., computers, computing devices, virtual machines, etc. can cause the machines to perform the operations described.

As shown in FIG. 1, the system 100 can comprise one or more servers 102, one or more networks 104, and/or host devices 106. The server 102 can comprise data pool component 108. The data pool component 108 can further comprise communications component 110. Also, the server 102 can comprise or otherwise be associated with at least one memory 112. The server 102 can further comprise a system bus 114 that can couple to various components such as, but not limited to, the data pool component 108 and associated components, memory 112 and/or a processor 116. While a server 102 is illustrated in FIG. 1, in other embodiments, multiple devices of various types (e.g., personal computers and/or other computerized devices) can be associated with or comprise the features shown in FIG. 1. Further, the server 102 can communicate with one or more cloud computing environments.

The one or more networks 104 can comprise wired and wireless networks, including, but not limited to, a cellular network, a wide area network (WAN) (e.g., the Internet) or a local area network (LAN). For example, the server 102 can communicate with the one or more host devices 106 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the data pool component 108 can be provided on the one or more servers 102, it should be appreciated that the architecture of system 100 is not so limited. For example, the data pool component 108, or one or more components of data pool component 108, can be located at another computer device, such as another server device, a client device, etc.

The one or more host devices 106 can be computer nodes within a distributed computing network. For example, the one or more host devices 106 can comprise one or more central processing units (“CPUs”) and/or graphics processing units (“GPUs”). Additionally, the one or more host devices 106 can comprise one or more drives, such as SSD and/or NVMe devices. In various embodiments, the system 100 can comprise a plurality of host devices 106, wherein the host devices 106 can communicate with each other and/or the server 102 via the one or more networks 104 and/or direct electrical connections. Further, the one or more host devices 106 can access one or more hierarchical collection of files 118 (e.g., stored in the one or more memories 112) via the one or more networks 104 and/or direct electrical connections. Moreover, one or more portions of the one or more hierarchical collection of files 118 can be stored, co-located, and/or collocated on one or more of the host devices 106.

In various embodiments, one or more host devices 106 of the system 100 can be employed to analyze, update, edit, monitor, and/or otherwise manipulate the one or more hierarchical collection of files 118. The collection of files 118 can be organized in one or more hierarchical structures, such as, for example, a non-linear data structure (e.g., a tree structure). For example, the system 100 can be employed to utilize the one or more host devices 106 to generate one or more operation requests across the distributed computing network. For instance, the one or more host devices 106 can be comprised within a distributed computing network that can facilitate training of one or more machine learning models.

The data pool component 108 can manage a file system directory regarding the location, status, and/or access properties of data comprised within the one or more hierarchical collection of files 118 by communicating with the one or more host devices 106 to direct data traffic across the network 104. Further, the data pool component 108 can perform one or more semantic analyses of data access patterns across the distributed computing network of host devices 106 by partitioning file system objects independently of the directory structure and into groups with one or more defined temporary access restrictions. For example, the data pool component 108 can partition one or more virtual address spaces into one or more continuous sections to organize metadata separated from the data within the one or more hierarchical collection of files 118. The metadata can be packaged into groups within the one or more continuous sections of virtual address space based on the observed data access patterns. Further, in various embodiments the data pool component 108 can adjust the partitioning of the metadata so as to enable localization of decisions regarding status and/or access permissions of the data to minimize requests across the network 104 based on recurring access patterns (e.g., by one or more vertical and/or horizontal tree splits and/or mergers that can re-organize the metadata partitioning).

The communications component 110 can facilitate communication between the data pool component 108, and/or its associate components, and the one or more host devices 106 by one or more direct electrical connections and/or the one or more networks 104. Additionally, the communications component 110 can monitor one or more communications between the host devices 106 (e.g., by serving as an intermediary between data traffic between the host devices 106).

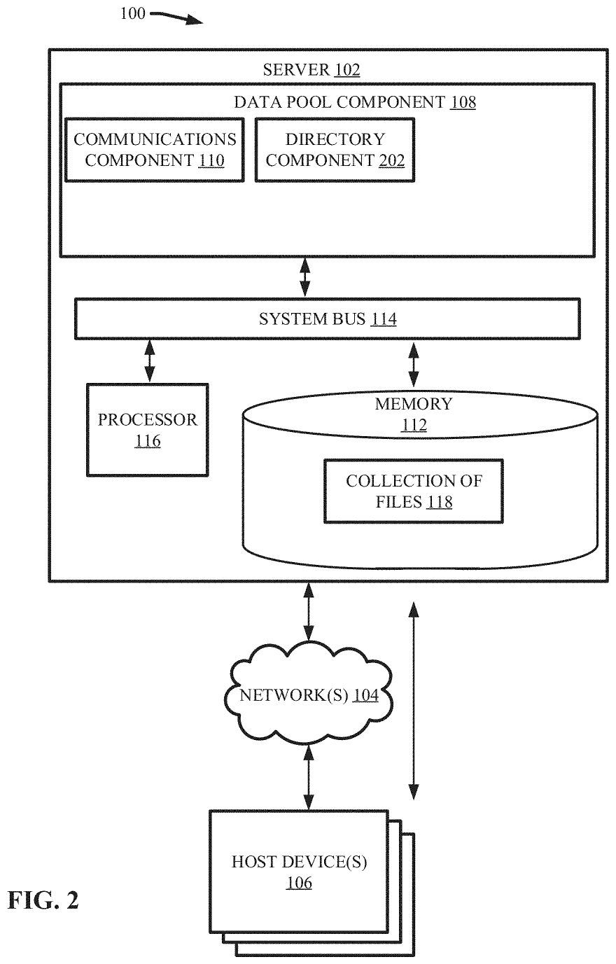

FIG. 2 illustrates a diagram of the example, non-limiting system 100 further comprising directory component 202 in accordance with one or more embodiments described herein. Repetitive description of like elements employed in other embodiments described herein is omitted for sake of brevity. In various embodiments, the directory component 202 can generate and/or manage one or more directory structures, such as sector directories and/or object dictionaries, to characterize the location, hierarchy, status, and/or access properties of the data within the distributed computing network of host devices 106. For example, the directory component 202 can generate and/or manage the one or more directory structures by mapping a sequence of sectors from the one or more host devices 106.

In one or more embodiments the directory component 202 can organize a sequence of sectors on the host devices 106 into one or more address sections. For example, the directory component 202 can map the sectors on the host devices 106 such that the sectors can be identified by a single 64-bit number. For example, wherein “H” host devices 106 comprise “D[h]” drives, the directory component 202 can define a number of sectors “S[h,d]” for a given drive “[h,d]”. Further, the directory component 202 can order the host devices 106 within a sector map based on sector capacities and/or can delineate host devices 106 by an offset value. For instance, a first host device 106 (“H1”) can have an offset value of zero and a capacity value of 10⁶, thereby a second host device (“H2”) can have an offset value of 10⁶ (e.g., based on the capacity value of the previous host device 106 H1) and a capacity value of 10⁷, whereupon a third host device (“H3”) can have an offset value of 10⁶+10⁷ (e.g., based on the cumulative capacity of the previous host devices 106 H1+H2), and so on for each of the host devices 106. Thus, the directory component 202 can generate the sector map by ordering the sectors into a self-balancing binary tree (e.g., a node-based binary search tree that automatically minimizes its height despite data insertions and/or deletions), wherein the directory component 202 can assign identification numbers to each of the sectors based on the host device 106 upon which the given sector is located and/or the capacity of the respective host device 106. Also, each host device 106 can access a copy of the sector map (e.g., access the self-balancing binary tree via the communications component 110 and the one or more networks 104). Thereby, remote requests to the distributed computing network can become sector requests via a single identification number (e.g., a single 64-bit number).

Additionally, the directory component 202 can generate one or more object trees that can map file system objects comprised within the one or more hierarchical collection of files 118 to one or more metadata blocks based on one or more offset values. For example, the directory component 202 can map the file system objects to metadata blocks that comprise ownership data, permission data, time stamp data, and/or content reference data associated with the given file system objects. In various embodiments, the metadata blocks can share the same memory footprint and/or can be processed utilizing memory management that is specific to a section of virtual address space associated with the metadata block. Short object names can be included in the metadata block; otherwise object names can be augmented within the one or more object tree. In one or more embodiments, the directory component 202 can utilize a radix tree, such as a Patricia tree, or a self-balancing binary tree, such as a Red-Black tree, to map the file system objects and metadata blocks. Further, the hierarchical structure (e.g., radix tree structure and/or self-balancing binary tree structure) can comprise link information (e.g., characterizing a correlation between a location in the tree and a section of virtual address space of the metadata) and/or file information (e.g., delineating one or more of the defined sectors associated with a given file) directly into the blocks of the data-tree topology.

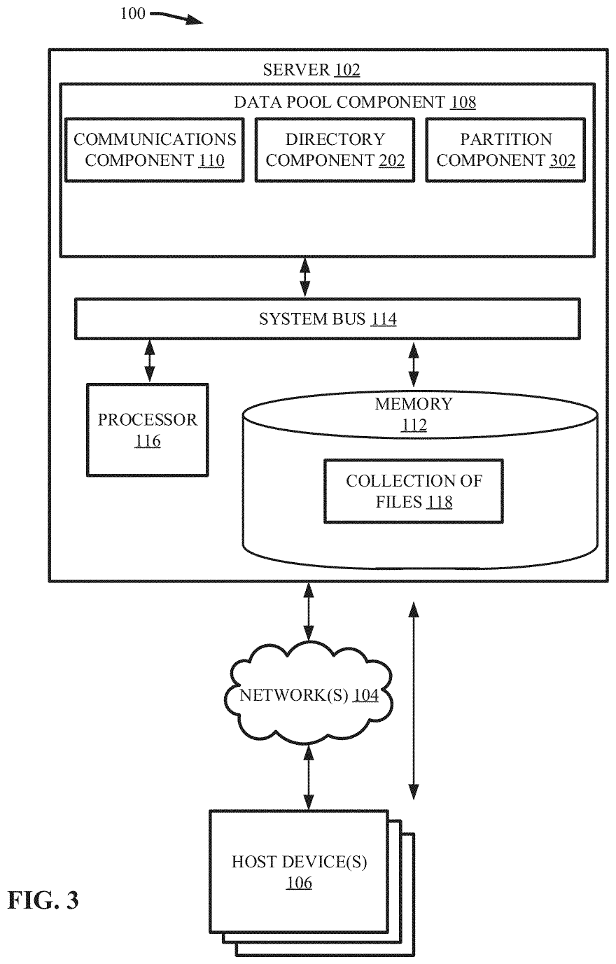

FIG. 3 illustrates a diagram of the example, non-limiting system 100 further comprising partition component 302 in accordance with one or more embodiments described herein. Repetitive description of like elements employed in other embodiments described herein is omitted for sake of brevity. In various embodiments, the partition component 302 can separate metadata from the data of the one or more hierarchical collection of files 118 and/or characterized by the one or more directory structures generated by the directory component 202 into one or more continua. For example, the partition component 302 can separate the metadata by partitioning the metadata into the one or more continua based on one or more data access patterns and/or temporary access limitations associated with the metadata.

As used herein, the term “continuum” and/or “continua” can refer to one or more continuous sections of one or more virtual address spaces. The one or more continua can be a subtree of the object tree, and the one or more continua can have respective memory allocators. In various embodiments, the partition component 302 can group the metadata within the one or more continua in a different order than the tree-hierarchy of the associate data. The one or more continua can exhibit a large granularity to efficiently load, transfer, and/or write metadata with the distributed computing network of host devices 106. In various embodiments, the partition component 302 can allocate one or more sections of virtual address space without the one or more sections being backed by physical memory. Thereby the data pool component 108 build and/or adjust small-granularity linked data structures that have a specific larger granularity organization in one or more virtual address spaces without having to account for prior sizing properties.

For example, the virtual address spaces of the one or more continua can initially be not backed by physical memory, wherein virtual address space subsets covered by any two different continua can be disjoint. The creation of a continuum can reserve a section of the virtual address space that is not backed by physical memory (e.g., physical backing of pages can be added as the virtual address space is accessed by tasks). Additionally, the release of a given continuum can return the section of virtual address space to the service on the one or more host device 106 from which it was obtained. In various embodiments, no central directory is necessary to manage the virtual address space since the address ranges covered by different continua are disjoint.

Further, dynamic growth of the one or more continua can be handled by the partition component 302 by using increasingly sized sections of the virtual address space (e.g., wherein a total number of sections in a give continua can be equal to O log(S)), with “S” being the size of the given continuum in bytes). Upon creating a continua, the partition component 302 can generate one or more data structures for a malloc subsystem in a first section of the virtual address space. Thereupon, selection of a given continuum can redirect memory management to utilize a distinct memory allocator of the continuum, wherein the memory allocator can increase the break in the virtual address space section until the capacity of the section is reached, then the partition component 302 can add another section.

In various embodiments, the partition component 302 can manage one or more temporary access rights of the metadata on the continua level. Example temporary access rights that can be defined by the partition component 302 with regards to the one or more continua can include, but are not limited to: an exclusive command, a read-only command, a copy-on-write command, a combination thereof, and/or the like. Further, decisions regarding the one or more temporary access rights can be made local to the given host devices 106 (e.g., so long as the use is in accordance with a usage domain). Blocks of metadata can be assessed via one or more start addresses and one or more offset values (e.g., one or more continua can be relocated between subtree positioned by changing one or more values of the one or more virtual address spaces). In various embodiments, the number of continua can be orders of magnitude smaller than the number of file system objects. Additionally, the partition component 302 can identify the one or more continua by one or more virtual-to-physical continuum address tables. Further, the partition component 302 can characterize the one or more continua by a temporary access state that does not change file permissions and can reflect the most likely access pattern for the associate data based on observed access patterns.

In one or more embodiments, the partition component 302 can generate one or more first continua that can hold a data structure, such as a binary tree for file properties as names, data access times, and/or the like. Also, the partition component 302 can generate one or more second continua that can hold a collection of sector-blocks in a binary tree, wherein each sector-block can contain references to physical sectors in the one or more host devices 106. The binary trees, and hence the continua, can be linked through one or more tree operations (e.g., vertical and/or horizontal splits). Further, the sector-blocks can be linked to the associated tree entries.

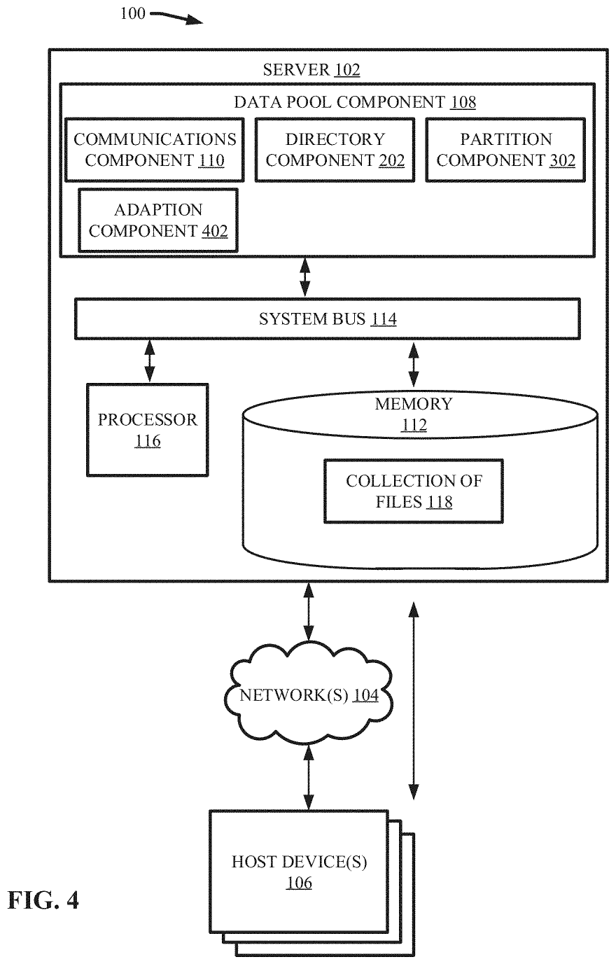

In one or more embodiments, the partition component 302 can further journal the continua layout by regularly committing the state of the one or more continua to a disk space. Additionally, the partition component 302 can write to a disk space a sequential list of any metadata modifications (e.g., modifications performed by the adaption component 402 and described with regards to FIG. 4 below).

FIG. 4 illustrates a diagram of the example, non-limiting system 100 further comprising adaption component 402 in accordance with one or more embodiments described herein. Repetitive description of like elements employed in other embodiments described herein is omitted for sake of brevity. In various embodiments, the adaption component 402 can dynamically adjust the one or more continua by one or more split and/or merge operations based on one or more observed data access patterns.

In one or more embodiments, the adaption component 402 can perform one or more split or merger operations to dynamically adjust the position and/or composition of the one or more continua. For example, the adaption component 402 can perform one or more vertical splits, horizontal splits, vertical mergers, and/or horizontal mergers to the tree-hierarchy. In various embodiments, the adaption component 402 can: add one or more new continua to an existing subtree (e.g., whereupon one or more of the continua can be merged at later point in time), split one or more continua (e.g., move contend out of a read-only continuum), compact one or more continua (e.g., reorganize one or more continua that become sparse in relation to a defined threshold), employ machine learning to optimize one or more continua layouts based on usage history and/or the like.

In various embodiments, the adaption component 402 can compact one or more continua incrementally via holes in the virtual memory section. For example, the adaption component 402 can move a continua block from its location to a hole in the virtual memory section while updating the tree-hierarchy. Further, the adaption component 402 can generate one or more links to augment the tree-hierarchy so as to create references between continua.

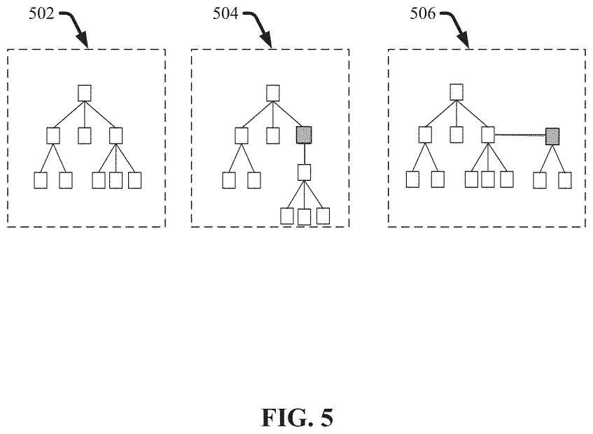

FIG. 5 illustrates a diagram of example, non-limiting tree operations that can be performed by the data pool component 108 (e.g., via partition component 302 and/or adaption component 402) to generate and/or modify one or more continua in accordance with one or more embodiments described herein. Repetitive description of like elements employed in other embodiments described herein is omitted for sake of brevity. As shown in FIG. 5, stage 502 depicts a tree-hierarchy prior to one or more tree operations that can be performed to generate and/or modify one or more continua. In the tree-hierarchy of FIG. 5, the boxes can represent one or more continua, wherein shaded boxes can represent a newly generated and/or modified continuum. Stage 504 depicts a vertical split tree operation that can be performed by the partition component 302 and/or adaption component 402 to generate and/or modify one or more continuum. For example, the vertical split tree operation depicted in stage 504 can regard splitting a continuum. Stage 506 depicts a horizontal split tree operation that can be performed by the partition component 302 and/or adaption component 402 to generate and/or modify one or more continuum. For example, the horizontal split tree operation depicted in stage 506 can regard adding one or more files 118 to a read-only continuum. In various embodiments, the one or more tree operations can be a logic-based split in which the mode of the subtree is affected or a physical split in which memory management operations are separated and data relocation can result. For example, blocks of the data-tree topology associated with metadata partitioned into the one or more continua can be accessed via start addresses and offset values, such that the one or more continua can be relocated within the tree-hierarchy by changing a value of the given continuum's address. For instance, the address value of blocks can be changed to merge blocks with other blocks pre-existing on the data-tree topology and/or to relocate one or more first continua associated with a block away from one or more second continua associated with the given block (e.g., as shown in stage 504 and/or 506).

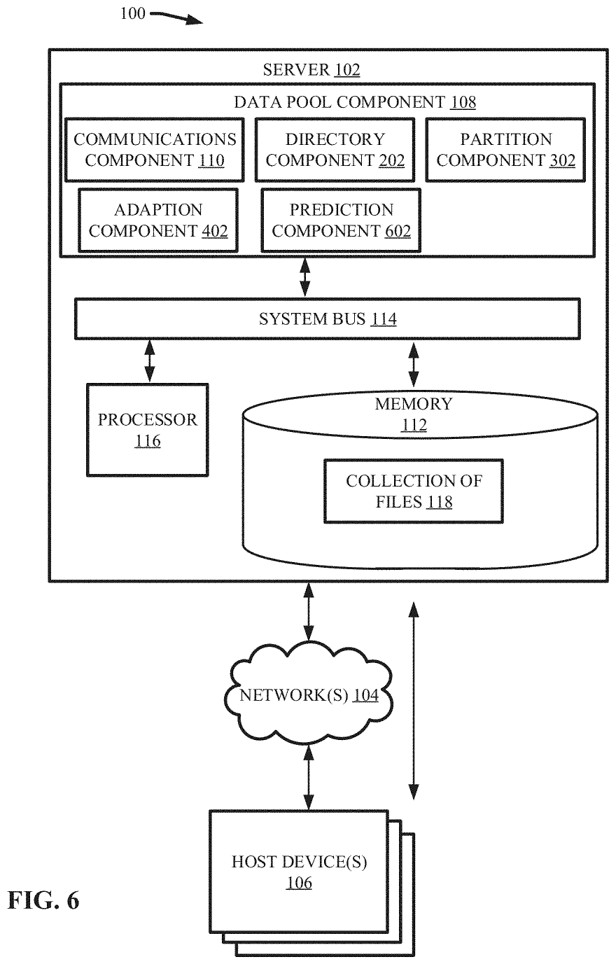

FIG. 6 illustrates a diagram of the example, non-limiting system 100 further comprising prediction component 602 in accordance with one or more embodiments described herein. Repetitive description of like elements employed in other embodiments described herein is omitted for sake of brevity. In various embodiments, the prediction component 602 can employ one or more machine learning technologies to predict one or more future data access patterns of the data, wherein one or more of the continua can be generated and/or adjusted (e.g., via one or more split or merge operations described herein) based on the one or more predicted future data access patterns.

In one or more embodiments, the prediction component 602 can use machine learning to continuously train a deep learning model that can predict near future access patterns. Further, the prediction component 602 can collect latency, remote access, and/or local access information to model an optimal continua layout and/or data distribution. In various embodiments, the adaption component 402 can further adjust one or more continua based on the one or more deep learning models trained by the prediction component 602. For example, one or more continua can be generated and/or adjusted (e.g., via the adaption component 402) based on one or more predicted access patterns generated by the prediction component 602.

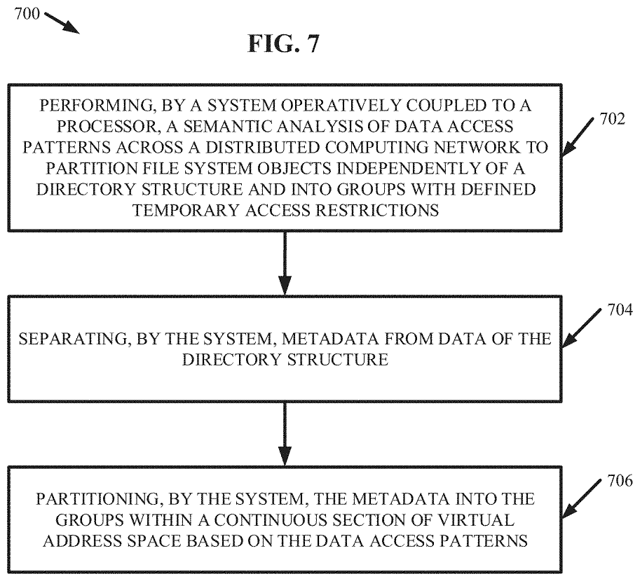

FIG. 7 illustrates a flow diagram of an example, non-limiting computer-implemented method that can partition file system objects independently of one or more directory structures into groups with temporary limitations in accordance with one or more embodiments described herein. Repetitive description of like elements employed in other embodiments described herein is omitted for sake of brevity.

At 702, the computer-implemented method 700 can comprise performing (e.g., via data pool component 108), by a system 100 operatively coupled to a processor 116, a semantic analysis of data access patterns across a distributed computing network to partition file system objects independently of a directory structure and into group with defined temporary access restrictions. As described herein, the computer-implemented method (e.g., via data pool component 108) can partition one or more virtual address spaces into one or more continuous sections to organize metadata separated from the data within the one or more hierarchical collection of files 118. The metadata can be packaged into groups within the one or more continuous sections of virtual address space based on the observed data access patterns. Further, in accordance with the various embodiment described herein the computer-implemented method (e.g., via data pool component 108) can adjust the partitioning of the metadata so as to enable localization of decisions regarding status and/or access permissions of the data to minimize requests across the network 104 based on recurring access patterns (e.g., by one or more vertical and/or horizontal tree splits and/or mergers that can re-organize the metadata partitioning). For instance, at 704, the computer-implemented method 700 can comprise separating (e.g., via partition component 302), by the system 100, metadata from data of the directory structure. Additionally, at 706, the computer-implemented method 700 can comprise partitioning (e.g., via partition component 302), by the system 100, the metadata into groups within a continuous virtual memory section based on the data access patterns.

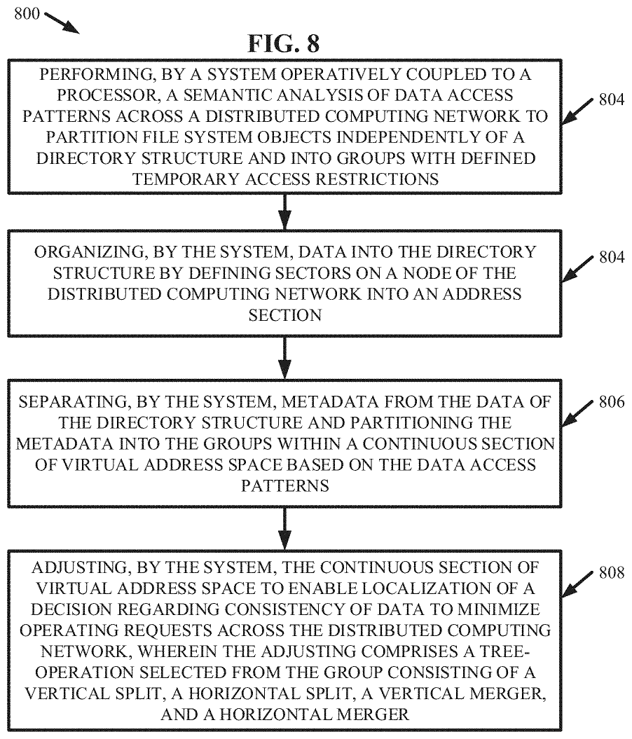

FIG. 8 illustrates a flow diagram of an example, non-limiting computer-implemented method that can partition file system objects independently of one or more directory structures into groups with temporary limitations in accordance with one or more embodiments described herein. Repetitive description of like elements employed in other embodiments described herein is omitted for sake of brevity.

At 802, the computer-implemented method 800 can comprise performing (e.g., via data pool component 108), by a system 100 operatively coupled to a processor 116, a semantic analysis of data access patterns across a distributed computing network to partition file system objects independently of a directory structure and into groups with defined temporary access restrictions (e.g., via the data pool component 108). As described herein, the computer-implemented method (e.g., via data pool component 108) can partition one or more virtual address spaces into one or more continuous sections to organize metadata separated from the data within the one or more hierarchical collection of files 118. The metadata can be packaged into groups within the one or more continuous sections of virtual address space based on the observed data access patterns. Further, in accordance with the various embodiment described herein the computer-implemented method (e.g., via data pool component 108) can adjust the partitioning of the metadata so as to enable localization of decisions regarding status and/or access permissions of the data to minimize requests across the network 104 based on recurring access patterns (e.g., by one or more vertical and/or horizontal tree splits and/or mergers that can re-organize the metadata partitioning). For instance, at 804, the computer-implemented method 800 can comprise organizing, by the system 100, data into the directory structure by defining sectors on a node (e.g., one or more host devices 106) of the distributed computing network into one or more address sections (e.g., via the directory component 202). Additionally, at 806, the computer-implemented method 800 can comprise separating, by the system 100, metadata from the data of the directory structure and partitioning the metadata into the groups within a continuous virtual memory section based on the data access patterns (e.g., via the partition component 302). Also, at 808, the computer-implemented method 800 can comprise adjusting, by the system 100, one or more continuous sections of the virtual address space to enable localization of a decision regarding consistency of the data to minimize operating requests across the distributed computing network, wherein the adjusting can comprise one or more tree-operations selected from the group consisting of a vertical split, a horizontal split, a vertical merger, and/or a horizontal merger (e.g., via the adaption component 402). For example, the adjusting can be performed in accordance with the one or more tree operations depicted in FIG. 5.

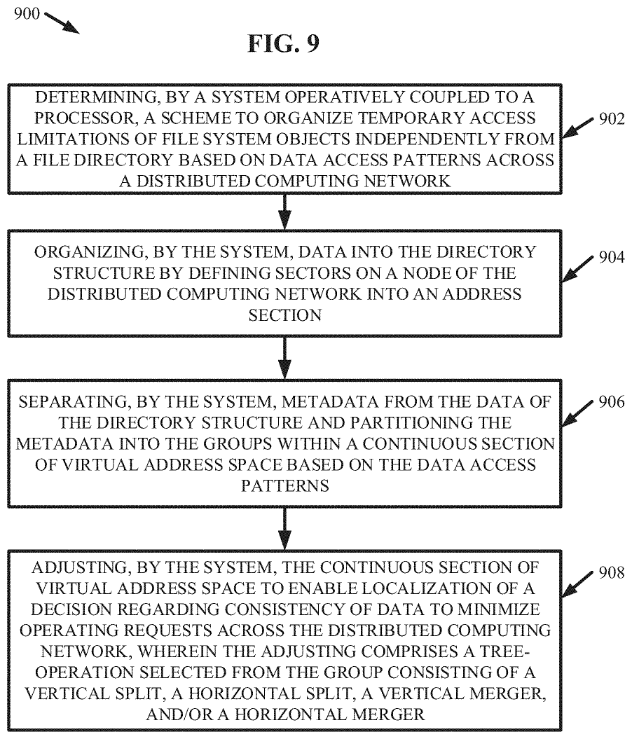

FIG. 9 illustrates a flow diagram of an example, non-limiting computer-implemented method 900 that can partition file system objects independently of one or more directory structures into groups with temporary limitations in accordance with one or more embodiments described herein. Repetitive description of like elements employed in other embodiments described herein is omitted for sake of brevity.

At 902, the computer-implemented method 900 can comprise determining, by a system 100 operatively coupled to a processor 116, a scheme to organize temporary access limitations of file system objects independently from a file system directory based on data access patterns across a distributed computing network (e.g., via the data pool component 108). As described herein, the computer-implemented method (e.g., via data pool component 108) can partition one or more virtual address spaces into one or more continuous sections to organize metadata separated from the data within the one or more hierarchical collection of files 118. The metadata can be packaged into groups within the one or more continuous sections of virtual address space based on the observed data access patterns. Further, in accordance with the various embodiments described herein, the computer-implemented method (e.g., via data pool component 108) can adjust the partitioning of the metadata so as to enable localization of decisions regarding status and/or access permissions of the data to minimize requests across the network 104 based on recurring access patterns (e.g., by one or more vertical and/or horizontal tree splits and/or mergers that can re-organize the metadata partitioning). For instance, at 904, the computer-implemented method 900 can comprise organizing data, by the system 100, into the file system directory by defining sectors on a node of the distributed computing network into one or more address sections (e.g., via the directory component 202). Additionally, at 906, the computer-implemented method 900 can comprise separating metadata from the data of the file system directory and partitions the metadata into groups within a continuous virtual memory section based on the data access patterns (e.g., via the partition component 302). Also, at 908, the computer-implemented method 900 can comprise adjusting one or more continuous sections of the virtual address space to enable localization of a decision regarding consistency of the data to minimize operating requests across the distributed computing network, wherein the adjusting comprises a tree-operation selected from the group consisting of a vertical split, a horizontal split, a vertical merger, and/or a horizontal merger (e.g., via the adaption component 402).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

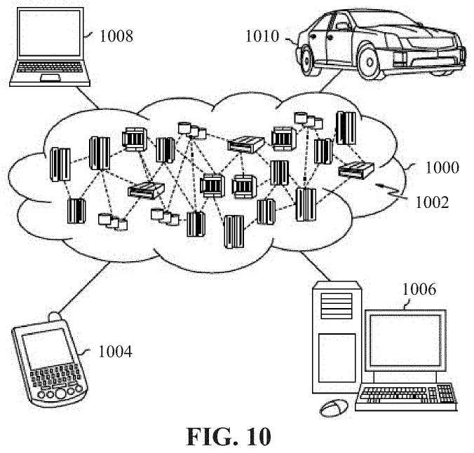

Referring now to FIG. 10, illustrative cloud computing environment 1000 is depicted. As shown, cloud computing environment 1000 includes one or more cloud computing nodes 1002 with which local computing devices used by cloud consumers, such as, for example, personal digital assistant (PDA) or cellular telephone 1004, desktop computer 1006, laptop computer 1008, and/or automobile computer system 1010 may communicate. Nodes 1002 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1004-1010 shown in FIG. 10 are intended to be illustrative only and that computing nodes 1002 and cloud computing environment 1000 can communicate with any type of computerized device over any type of network and/or network addressable connection (e.g., using a web browser).

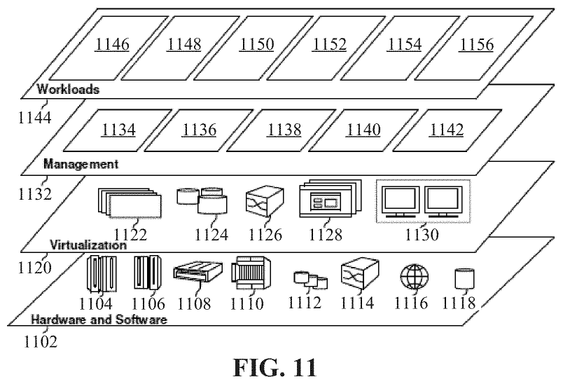

Referring now to FIG. 11, a set of functional abstraction layers provided by cloud computing environment 1000 (FIG. 10) is shown. Repetitive description of like elements employed in other embodiments described herein is omitted for sake of brevity. It should be understood in advance that the components, layers, and functions shown in FIG. 11 are intended to be illustrative only and embodiments of the invention are not limited thereto. As depicted, the following layers and corresponding functions are provided.

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and data indexing and/or access management 1156. Various embodiments of the present invention can utilize the cloud computing environment described with reference to FIGS. 10 and 11 to partition file system objects independently of one or more directory structures into groups with temporary limitations in accordance with one or more embodiments described herein.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

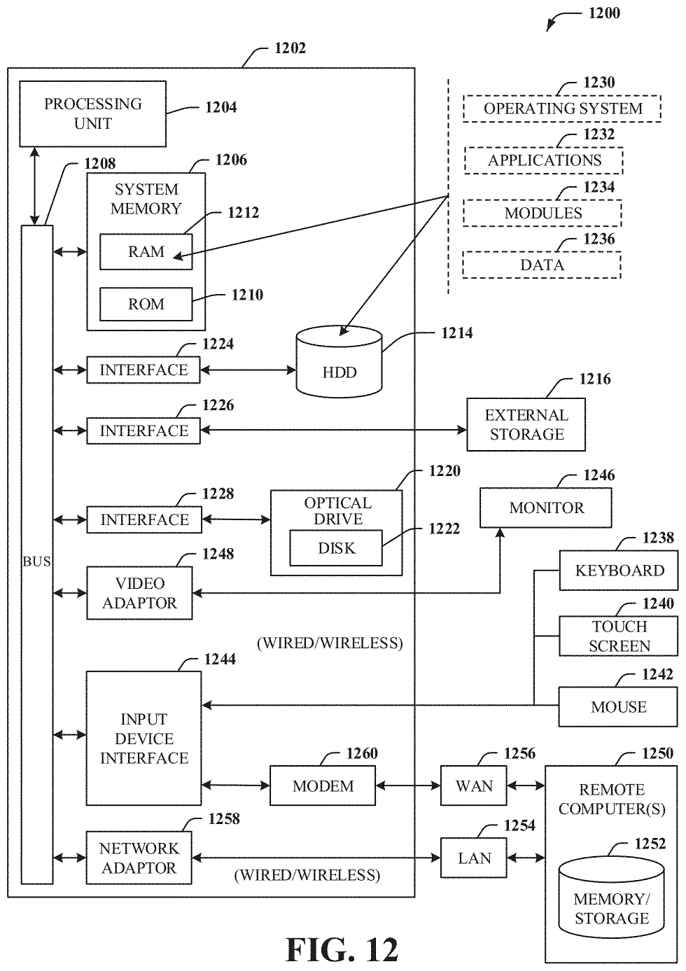

In order to provide additional context for various embodiments described herein, FIG. 12 and the following discussion are intended to provide a general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (“BIOS”) can be stored in a non-volatile memory such as ROM, erasable programmable read only memory (“EPROM”), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (“HDD”) 1214 (e.g., EIDE, SATA), one or more external storage devices 1216 (e.g., a magnetic floppy disk drive (“FDD”) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (“SSD”) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (“VM”) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (“TPM”). For instance with a TPM, boot components hash next in time boot components, and wait for a match of results to secured values, before loading a next boot component. This process can take place at any layer in the code execution stack of computer 1202, e.g., applied at the application execution level or at the operating system (“OS”) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (“LAN”) 1254 and/or larger networks, e.g., a wide area network (“WAN”) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (“AP”) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (“Wi-Fi”) and BLUETOOTH® wireless technologies. Thus, the communication can be a predefined structure as with a conventional network or simply an ad hoc communication between at least two devices.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor, operably coupled to the memory, and that executes the computer executable components stored in the memory, wherein the computer executable components comprise:
a data pool component that performs a semantic analysis of data access patterns across a distributed computing network to partition file system objects independently of a directory structure and into groups with defined temporary access restrictions.

2. The system of claim 1, further comprising:
a directory component that organizes data into the directory structure by defining sectors on a node of the distributed computing network into an address space.

3. The system of claim 2, further comprising:
a partition component that separates metadata from the data of the directory structure and partitions the metadata into the groups within a continuous section of virtual address space based on the data access patterns.

4. The system of claim 3, further comprising:
an adaption component that dynamically adjusts the continuous section of virtual address space to enable localization of a decision regarding consistency of the data to minimize operating requests across the distributed computing network.

5. The system of claim 4, wherein the adaption component dynamically adjusts the continuous section of virtual address space via a tree-operation selected from the group consisting of a vertical split, a horizontal split, a vertical merger, and a horizontal merger.

6. The system of claim 5, further comprising:
a prediction component employs machine learning to predict a future data access pattern of a file system object, wherein the partition component further partitions the metadata based on the future data access pattern.

7. A system, comprising:
a memory that stores computer executable components; and
a processor, operably coupled to the memory, and that executes the computer executable components stored in the memory, wherein the computer executable components comprise:
a data pool component that determines a scheme to organize temporary access limitations of file system objects independently from a file system directory based on data access patterns across a distributed computing network.

8. The system of claim 7, further comprising:
a directory component that organizes data into the file system directory by defining sectors on a node of the distributed computing network into an address space.

9. The system of claim 8, further comprising:
a partition component that separates metadata from the data of the file system directory and partitions the metadata into groups within a continuous section of virtual address space based on the data access patterns.

10. The system of claim 9, further comprising:
an adaption component that dynamically adjusts the continuous section of virtual address space to enable localization of a decision regarding consistency of the data to minimize operating requests across the distributed computing network.

11. The system of claim 10, wherein the adaption component dynamically adjusts the continuous section of virtual address space via a tree-operation selected from the group consisting of a vertical split, a horizontal split, a vertical merger, and a horizontal merger.

12. A computer-implemented method, comprising:
performing, by a system operatively coupled to a processor, a semantic analysis of data access patterns across a distributed computing network to partition file system objects independently of a directory structure and into groups with defined temporary access restrictions.

13. The computer-implemented method of claim 12, further comprising:
organizing, by the system, data into the directory structure by defining sectors on a node of the distributed computing network into an address space.

14. The computer-implemented method of claim 13, further comprising:
separating, by the system, metadata from the data of the directory structure; and
partitioning, by the system, the metadata into the groups within a continuous section of virtual address space based on the data access patterns.

15. The computer-implemented method of claim 14, further comprising:
adjusting, by the system, the continuous section of virtual address space to enable localization of a decision regarding consistency of the data to minimize operating requests across the distributed computing network, wherein the adjusting comprises a tree-operation selected from the group consisting of a vertical split, a horizontal split, a vertical merger, and a horizontal merger.

16. A computer-implemented method, comprising:
determining, by a system operatively coupled to a processor, a scheme to organize temporary access limitations of file system objects independently from a file system directory based on data access patterns across a distributed computing network.

17. The computer-implemented method of claim 16, further comprising:
organizing, by the system, data into the file system directory by defining sectors on a node of the distributed computing network into an address space.

18. The computer-implemented method of claim 17, further comprising:
separating, by the system, metadata from the data of the file system directory; and
partitioning, by the system, the metadata into groups within a continuous section of virtual address space based on the data access patterns.

19. The computer-implemented method of claim 18, further comprising:
adjusting, by the system, the continuous section of virtual address space to enable localization of a decision regarding consistency of the data to minimize operating requests across the distributed computing network, wherein the adjusting comprises a tree-operation selected from the group consisting of a vertical split, a horizontal split, a vertical merger, and a horizontal merger.

20. A computer program product for managing data comprised within a distributed computing network, the computer program product comprising a computer readable storage medium having program instructions embodied therewith, the program instructions executable by a processor to cause the processor to:
perform, by the processor, a semantic analysis of data access patterns across a distributed computing network to partition file system objects independently of a directory structure and into groups with defined temporary access restrictions.

21. The computer program product of claim 20, wherein the program instructions further cause the processor to:
organize, by the processor, the data into the directory structure by defining sectors on a node of the distributed computing network into an address space.

22. The computer program product of claim 21, wherein the program instructions further cause the processor to:
separate, by the processor, metadata from the data of the directory structure; and
partition, by the processor, partitions the metadata into the groups within a continuous section of virtual address space based on the data access patterns.

23. The computer program product of claim 20, wherein the distributed computing network is comprised within a cloud computing environment.

24. The computer program product of claim 22, wherein the program instructions further cause the processor to:
adjust, by the processor, the continuous section of virtual address space to enable localization of a decision regarding consistency of the data to minimize operating requests across the distributed computing network.

25. The computer program product of claim 24, wherein the processor adjusts the continuous section of virtual address space via a tree-operation selected from the group consisting of a vertical split, a horizontal split, a vertical merger, and a horizontal merger.
